(19) United States
(12) Patent Application Publication
(10) Pub. No.: US 2003/0002677 A1
(43) Pub. Date: Jan. 2, 2003

(54) Software implementations of input independent LFSR-based algorithms

(76) Inventors: Amit Dagan, Haifa (IL); Orly Abramovich, Netanya (IL)

Correspondence Address: Marina Portnova, BLAKELY, SOKOLOFF, TAYLOR & ZAFMAN LLP, 12400 Wilshire Boulevard, Seventh Floor, Los Angeles, CA, 90025-1026, US

(21) Appl. No.: 09/896,344

(22) Filed: Jun. 28, 2001

(51) Int. Cl. H04L 9/00

(52) U.S. Cl. 380/265

(57) ABSTRACT

A method and apparatus for software implementations of input independent LFSR-based algorithms are provided. In one embodiment, an initial location is identified in a cyclic sequence of entries representing a set of possible output values of a Linear Feedback Shift Register. Based on the initial location and a predefined group size, an initial group of entries is identified in the cyclic sequence of entries. Further, a predefined operation is performed on the initial group of entries in the cyclic sequence and an initial portion of input data. The predefined operation is repeated for each remaining portion of input data and a corresponding group of entries in the cyclic sequence.

### FIELD OF THE INVENTION

The present invention relates generally to the field of telecommunication, and more specifically to optimizing telecommunication algorithms that use a Linear Feedback Shift Register.

### BACKGROUND OF THE INVENTION

Open Systems Interconnection (OSI) is a standard description or “reference model” for how messages should be transmitted between any two points in a telecommunication network. The purpose of OSI is to guide product implementors so that their products will consistently work with other products. The reference model defines seven layers of functions that take place at each end of communication. The first layer (also referred to as the physical layer) conveys the bit stream through the network at the electrical and mechanical levels. The physical layer provides the hardware means of sending and receiving data on a carrier. The physical layer is defined by various specifications. For instance, the IEEE 802.11a standard, IEEE std. 802.11a-1999, published Dec. 30, 1999, defines the physical layer for wireless LAN communications, the Bluetooth™ specification, Bluetooth™, v1.0 B, published Dec. 1, 1999, defines the physical layer for communications involving mobile phones, computers, and personal digital assistants, etc.

A number of current physical layer algorithms use Linear Feedback Shift Register (LFSR) to process input data. LFSR is an n-element shift register where values in each element may be shifted into an adjacent element. The values move from element to element in response to the clock. The values in some elements may be combined by a boolean logic operation. Typically, an LFSR-based algorithm performs one or more operations on LFSR output and the stream of input data. Examples of LFSR-based algorithms include the “Scrambler” and “Pilot Insertion” algorithms specified as part of the IEEE 802.11a-1999 standard, and the “Whitening” algorithm specified as part of the Bluetooth Specification Version 1.0B. The “Scrambler” algorithm is used to scramble the transmitted packets and to descramble the received packets. The “Scrambler” algorithm and the “Whitening” algorithm are capable of randomizing the data from highly redundant patterns and minimizing DC bias in the transmitted packets. The “Pilot Insertion” algorithm is responsible for adding known values into the transmitted signal so that the receiver can better tune the analog side.

Current implementations of the above algorithms use the dedicated hardware (i.e., an LFSR machine) to perform required operations on input data. The use of LFSR limits the size of input data that can be processed during one cycle. Specifically, hardware implementations of these algorithms can only process one bit of input data per cycle, resulting in inefficient and slow performance. Thus, a method for optimizing the performance of the above algorithms is needed.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an example of a hardware implementation of a scrambler algorithm, according to a prior art embodiment;

FIG. 2 is block diagram of a system for performing LFSR-based telecommunication algorithms, according to one embodiment of the present invention;

FIG. 3 is a flow diagram of a method for performing LFSR-based telecommunication algorithms, according to one embodiment of the present invention;

FIG. 4 is a flow diagram of a method for performing a scrambler algorithm, according to one embodiment of the present invention;

FIG. 5 illustrates data structures used in software implementation of the “Scrambler” algorithm, according to one embodiment of the present invention; and

FIG. 6 is a block diagram of one embodiment of a processing system.

### DESCRIPTION OF EMBODIMENTS

A method and apparatus for performing input independent LFSR-based algorithms are described. In the following description, for purposes of explanation, numerous specific details are set forth in order to provide a thorough understanding of the present invention. It will be apparent, however, to one skilled in the art that the present invention can be practiced without these specific details.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus. Instructions are executable using one or more processing devices (e.g., processors, central processing units, etc.).

The algorithms and displays presented herein are not inherently related to any particular computer or other apparatus. Various general purpose machines may be used with programs in accordance with the teachings herein, or it may prove convenient to construct more specialized apparatus to perform the required method steps. The required structure for a variety of these machines will appear from the description below. In addition, the present invention is not described with reference to any particular programming language. It will be appreciated that a variety of programming languages may be used to implement the teachings of the invention as described herein.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

The present invention relates to software implementations of telecommunication algorithms that use a linear feedback shift register (LFSR) with a finite sequence of storage element values that are not dependent on input data. Such algorithms may include, for example, the “Scrambler” and “Pilot Insertion” algorithms defined in the IEEE 802.11a standard, the “Whitening” algorithm defined in the Bluetooth™ specification, etc. Current implementations of the above algorithms process one bit of input data per cycle using an LFSR machine. LFSR is a structure for producing sequences that includes n storage elements used to execute a generator polynomial, as will be described in more detail below.

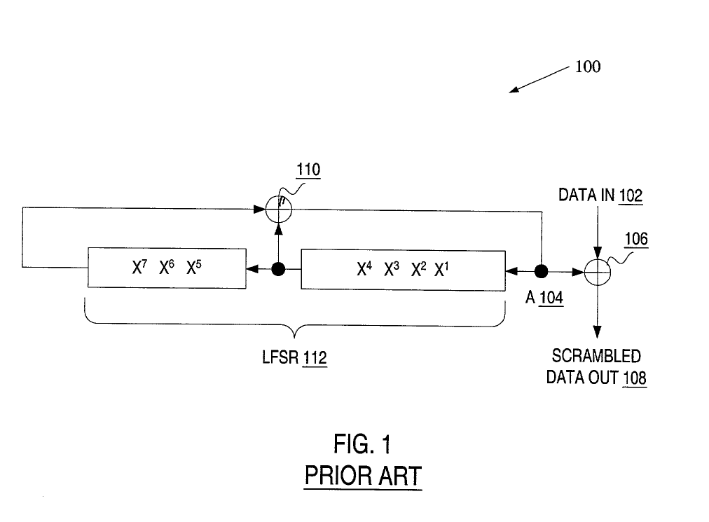

FIG. 1 is a block diagram of a machine 100 for implementing the “Scrambler” algorithm, according to a prior art embodiment. As described above, the “Scrambler” algorithm is capable of randomizing data from highly redundant patterns and minimizing DC bias in the transmitted packet. The “Scrambler” algorithm is used to scramble the transmitted packets and to descramble the received packets.

Referring to FIG. 1, machine 100 includes LFSR 112 which consists of 7 storage elements x¹ through x⁷. The values in storage elements x⁷ and x⁴ are combined by an exclusive-OR (XOR) operator 110 and the result is connected to the first element x¹, based on the generator polynomial S(x)=x⁷+x⁴+1. Machine 100 also includes a XOR operator 106 to combine the resulting output value of LFSR 112 with input data 102, thereby generating scrambled output data 108. Specifically, the “Scrambler” algorithm begins with initializing LFSR 112 with the appropriate value, and then running input data 102, bit-by-bit, on machine 100 to generate scrambled output data 108.

Machines similar to machine 100 are used in hardware implementations of the “Pilot Insertion” algorithm and the “Whitening” algorithm. Although the number of LFSR storage elements may be different for these algorithms, they all use LFSR with a finite sequence of possible states. An LFSR state represents a particular combination of values of LFSR storage elements. In one embodiment, the number of LFSR possible states is equal to 2ⁿ-1, where n is the number of LFSR storage elements. For instance, for the “Scrambler” algorithm, the number of LFSR states is 127. Alternatively, the number of LFSR possible states may be equal to a certain portion of the result from the 2ⁿ expression.

Further, for all of the above algorithms, the sequence of LFSR states is cyclic, i.e., the last state of LFSR is followed by the first state of LFSR in the sequence. The current state of LFSR depends only on the prior state of LFSR, and not on input data. Accordingly, the output of LFSR (the value at point 104) does not depend on the input data either.

The present invention provides a mechanism for performing such algorithms as “Scrambler”, “Whitening”, and “Pilot Insertion”, without implementing LFSR 112. It should be emphasized, however, that the mechanism of the present invention is not limited to the above algorithms and can be used for any other algorithm that is based on LFSR with a fixed cyclic sequence of states that are not dependent on input data.

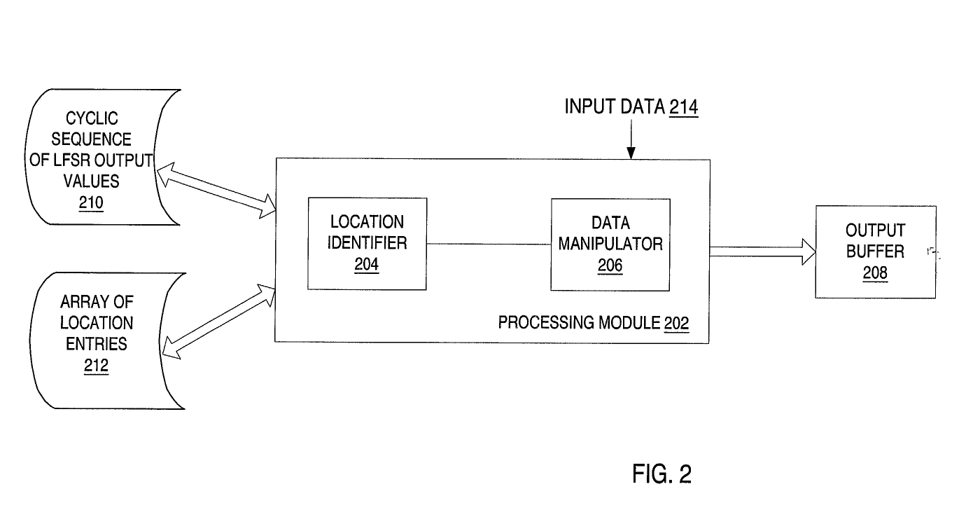

FIG. 2 is block diagram of a system 200 for performing LFSR-based telecommunication algorithms, according to one embodiment of the present invention. System 200 includes data structures 210 and 212, a processing module 202, and an output buffer 208. Data structure 210 includes a cyclic sequence of entries that represent a set of possible output values of LFSR (value at point 104). As described above, algorithms being implemented by the present invention (e.g., “Scrambler”, “Whitening”, “Pilot Insertion”, etc.) are based on LFSR with a fixed cyclic group of LFSR states. Using these states, a cyclic sequence of LFSR output values is determined and stored as data structure 210.

Data structure 212 includes an array of location entries. In one embodiment, each location entry contains a state of LFSR and a corresponding location in data structure 210. In one embodiment, each location identifies a certain record number in data structure 210.

Processing module 202 is responsible for processing input data 214 using the entries in cyclic sequence 210. In one embodiment, processing module 202 includes a location identifier 204 and a data manipulator 206. Location identifier 204 is responsible for identifying the initial location in cyclic sequence 210 from which the performance of a required operation should start. In one embodiment, the initial location is identified using array 212. That is, the initial location is selected from a number of location values stored in array 212 based on a given initial state of LFSR, as will be described in more detail below.

Data manipulator 206 is responsible for identifying an initial group of entries in cyclic sequence 210 based on a predefined group size and the initial location determined by location identifier 204. The initial group includes a group of entries of the predefined size that follow the initial location in cyclic sequence 210. Data manipulator 206 is further responsible for performing a predefined operation on the initial group of entries in cyclic sequence 210 and an initial portion of input data 214. The size of the initial portion of input data 214 is the same as the size of the initial group of entries in cyclic sequence 210. The predefined operation may include one or more operations required by the LFSR-based algorithm. For example, for the “Scrambler” algorithm, the predefined operation is an XOR operation. Other examples of predefined operations may include various boolean logic operations, data interleaving operations, data encoding operations, etc.

The predefined operation is repeated for each of the remaining portions of input data 214 and a corresponding group of entries in cyclic sequence 210. The size of each remaining portion of input data 214 and the size of each corresponding group of entries in cyclic sequence 210 are the same as the size of the initial group of entries in cyclic sequence 210. Data generated by data manipulator 206 is then stored in an output buffer 208.

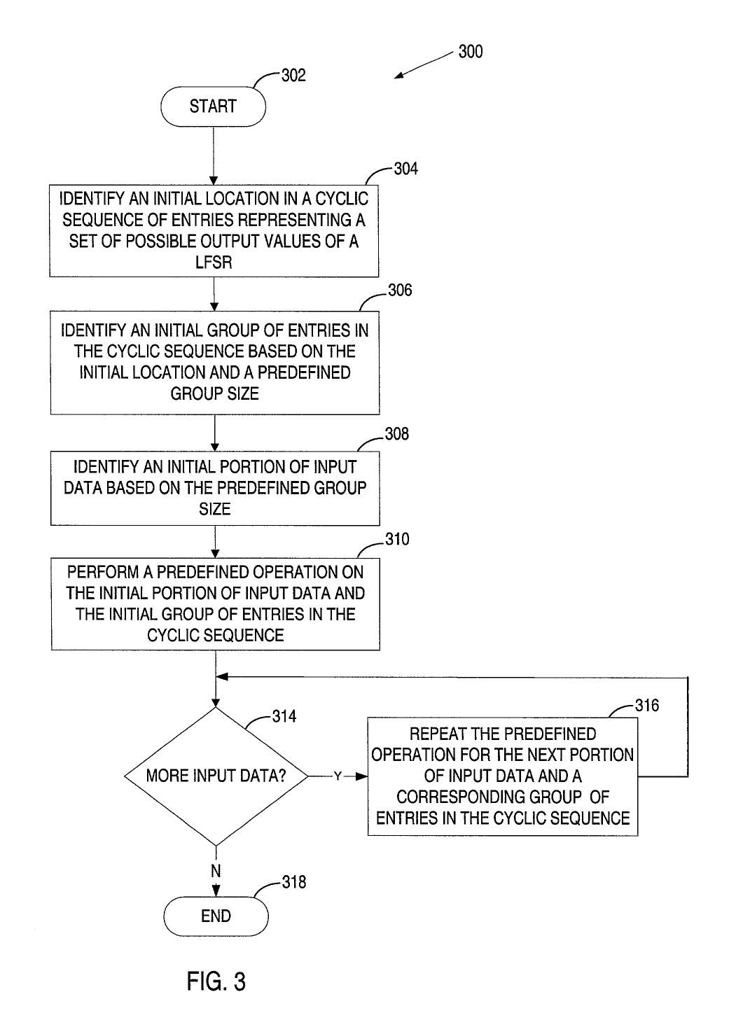

FIG. 3 is a flow diagram of a method 300 for performing an LFSR-based algorithm, according to one embodiment of the present invention. At processing block 304, an initial location from which the performance of the LFSR-based algorithm should start is identified in a cyclic sequence of entries representing a set of possible output values of LFSR. Because the present invention is used with algorithms that are based on LFSR with a fixed group of states that are not dependent on input data, all possible output values can be calculated before the algorithm is performed without implementing the LFSR itself. In one embodiment, the initial location is identified using an array of location entries. In one embodiment, each location entry in this array includes a state of LFSR and a corresponding location in the cyclic sequence of entries. The initial location can be found by searching the array of location entries using a given initial state of LFSR.

At processing block 306, an initial group of entries is identified in the cyclic sequence based on the initial location and a predefined group size. In one embodiment, the predefined group size is the size of a register in which the initial group of entries is stored when identified.

At processing block 308, an initial portion of input data is identified based on the predefined group size. In one embodiment, the initial portion of input data is then stored in a second register.

At processing block 310, a predefined operation is performed on the initial portion of input data and the initial group of entries in the cyclic sequence. The predefined operation may include one or more operations required by the LFSR-based algorithm. For example, for the “Scrambler” algorithm, the predefined operation is an XOR operation. In one embodiment, the result of the predefined operation is stored in a third register.

At decision box 314, a determination is made as to whether the entire input data has been processed. If the determination is negative, processing block 316 is performed. Otherwise, method 300 ends.

At processing block 316, the predefined operation is performed for the next portion of input data and the next group of entries in the cyclic sequence. The size of each group in the cyclic sequence is the same as the size of each portion of input data. This size is equal to the size of the initial portion of input data unless the size of the remaining input data is smaller than the size of the initial portion of input data. That is, the size of the two groups is also determined by the size of the remaining input data. Processing block 316 is repeated until the entire input data is processed.

Accordingly, the present invention provides a mechanism for processing a group of input data bits per cycle, as opposed to bit-by-bit processing in the dedicated hardware. As a result, the performance of LFSR-based algorithms is improved.

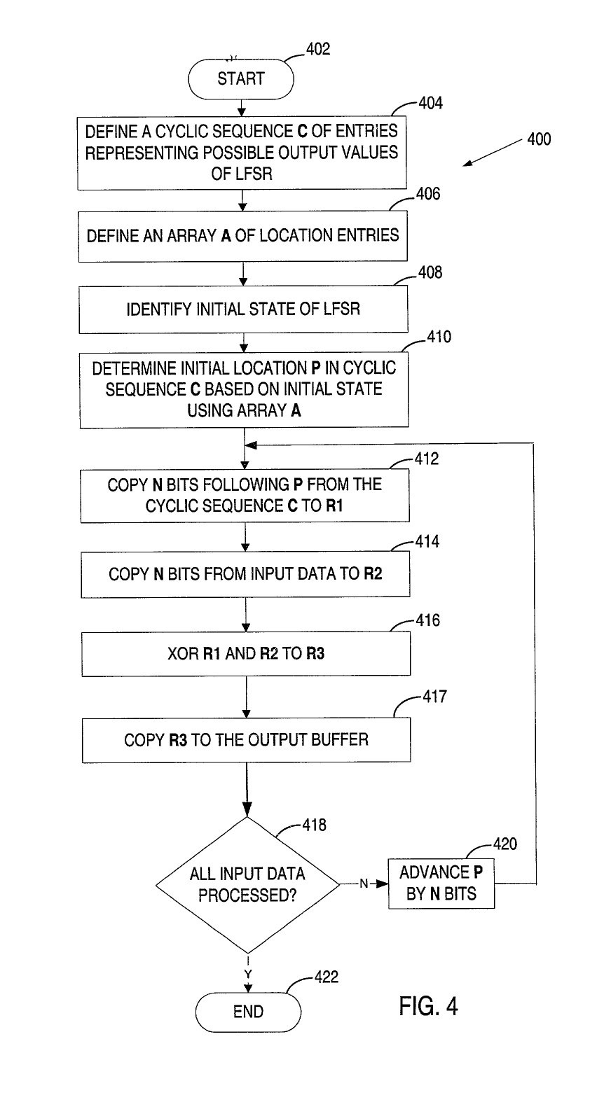

FIG. 4 is a flow diagram of a method 400 for performing a scrambler algorithm, according to one embodiment of the present invention. As described above, the “Scrambler” algorithm is used to scramble the transmitted packets and to descramble the received packets. The “Scrambler” algorithm uses the generator polynomial S(x)=x⁷+x⁴+1.

At processing block 404, cyclic sequence C is defined. Entries in the cyclic sequence C represent the set of all possible output values of the LFSR. The output values of LFSR are determined using the above generator polynomial. In one embodiment, cyclic sequence C is created in advance and stored in memory for subsequent use during each execution of the “Scrambler” algorithm. Alternatively, cyclic sequence C is created during the execution of the “Scrambler” algorithm.

At processing block 406, array A is defined. Each entry in array A includes a state of LFSR and a corresponding location in cyclic sequence C. In one embodiment, array A is created in advance and stored in memory for subsequent use during each execution of the “Scrambler” algorithm. Alternatively, array A is created during the execution of the “Scrambler” algorithm.

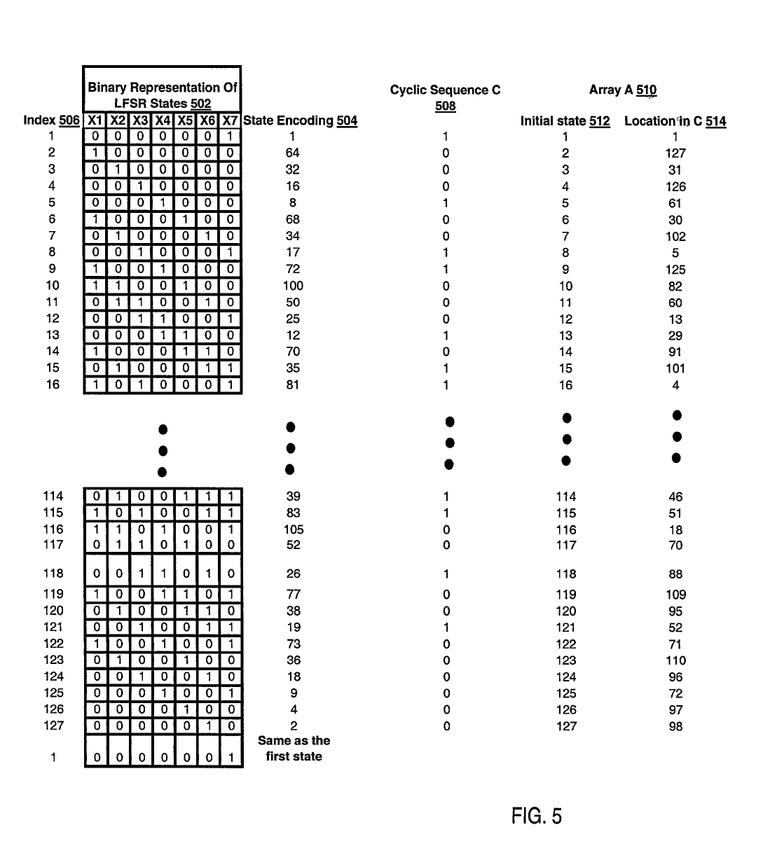

FIG. 5 illustrates data structures used in software implementation of the “Scrambler” algorithm, according to one embodiment of the present invention. These data structures include cyclic sequence C and array A. In cyclic sequence C (508), the entries represent the set of possible output values of the LFSR. Each entry is determined using a corresponding LFSR state 502. Each binary representation of LFSR state 502 is converted into a decimal value 504. Array A includes a group of LFSR states 512 represented in decimal form and corresponding locations in cyclic sequence C. Each location identifies a record number 506 in cyclic sequence C. Array A is sorted by state 512.

Returning to FIG. 4, at processing block 408, an initial LFSR state from which the required operation should start is identified. In one embodiment, the initial state of LFSR is encoded in the input data (e.g., in the first 7 bits of input data). In this embodiment (which may be used to descramble the received packets), the appropriate portion of the input data is decoded to determine the initial state of LFSR. Alternatively, an actual value of the initial state may be provided (e.g., by a prior phase), and no decoding is needed.

At processing block 410, initial location P from which the required operation should start is determined in cyclic sequence C based on the initial state of LFSR. Specifically, array A is searched using the initial state to find the initial location in cyclic sequence C.

At processing block 412, N bits following location P in cyclic sequence C are copied to register R1. At processing block 414, N bits of input data are copied to register R2. In one embodiment, the size of R1 and R2 is N bits. Alternatively, the size of R1 and/or R2 is greater than N bits.

At processing block 416, N bits from register R1 are XORed with N bits from register R2. The result of this operation is stored in register R3 and then copied to the output buffer (processing block 417).

At decision box 418, a determination is made as to whether the entire input data has been processed. If the determination is negative, at processing block 420, location P is advanced by N bits in cyclic sequence C, and processing flow returns to block 412. If needed, overflow calculations are performed when advancing location P and/or copying N bits following location P in cyclic sequence C. When the entire input data is processed, method 400 ends.

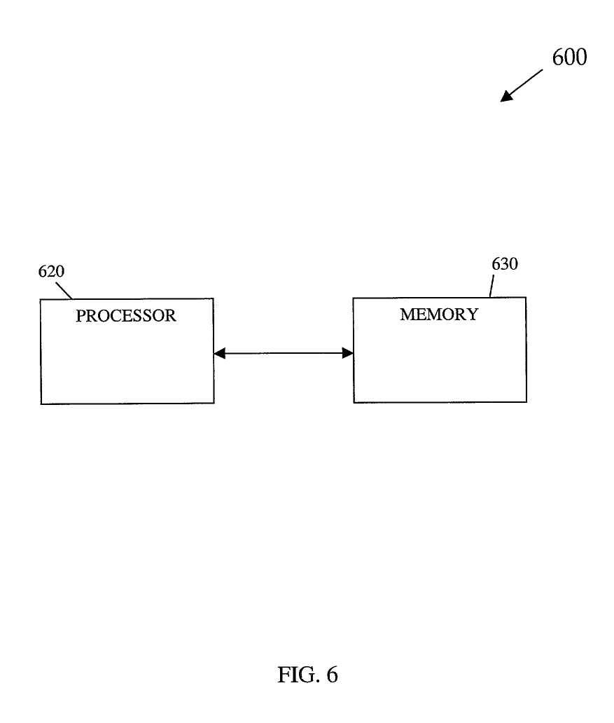

FIG. 6 is a block diagram of one embodiment of a processing system. Processing system 600 includes processor 620 and memory 630. Processor 620 can be any type of processor capable of executing software, such as a microprocessor, digital signal processor, microcontroller, or the like. Processing system 600 can be a personal computer (PC), mainframe, handheld device, portable computer, set-top box, or any other system that includes software.

Memory 630 can be a hard disk, a floppy disk, random access memory (RAM), read only memory (ROM), flash memory, or any other type of machine medium readable by processor 620. Memory 630 can hold data and also store instructions for performing the execution of the various method embodiments of the present invention such as methods 300 and 400 described above in conjunction with FIGS. 3 and 4.

Thus, a method and apparatus for performing LFSR-based algorithms have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computerized method comprising:
identifying an initial location in a cyclic sequence of entries representing a set of possible output values of a linear feedback shift register (LFSR);
identifying an initial group of entries in the cyclic sequence based on the initial location and a predefined group size;
identifying an initial portion of input data based on the predefined group size;
performing a predefined operation on the initial portion of input data and the initial group of entries in the cyclic sequence; and
repeating the predefined operation for each of the remaining portions of input data and a corresponding group of entries in the cyclic sequence.

2. The method of claim 1 further comprising:
determining the possible output values of the LFSR; and
storing the possible output values as the cyclic sequence of entries.

3. The method of claim 1 wherein the possible output values of the LSFR are not dependent on the input data.

4. The method of claim 1 further comprising:
defining an array of location entries, each location entry in the array including a state of the LFSR and an associated location in the cyclic sequence of entries; and
searching the array of location entries for the initial location in the cyclic sequence of entries using an initial state of the LFSR.

5. The method of claim 4 further comprising receiving the initial state of the LFSR with the input data.

6. The method of claim 4 further comprising decoding the input data to determine the initial state of the LFSR.

7. The method of claim 4 wherein each state of the LFSR is a decimal value resulting from conversion of a corresponding set of binary values of LFSR storage elements.

8. The method of claim 1 wherein executing the predefined operation further comprises:
storing the initial group of input data in a first register;
storing the initial group of input data in a second register; and
storing results of the predefined operation in a third register.

9. The method of claim 8 wherein the predefined group size is a size of the first register.

10. The method of claim 1 wherein the predefined operation is an XOR instruction.

11. The method of claim 1 wherein:
the LFSR includes 7 storage elements; and
the cyclic sequence includes 127 entries.

12. The method of claim 1 wherein the predefined operation is part of any one of a scrambler algorithm, a whitening algorithm, and a pilot insertion algorithm.

13. The method of claim 1 wherein each of the remaining portions of input data and a corresponding group of entries in the cyclic sequence are of the predefined group size.

14. An apparatus comprising:
a cyclic sequence of entries representing a set of possible output values of a linear feedback shift register (LFSR);
a location identifier to identify an initial location in the cyclic sequence of entries; and
a data manipulator to identify an initial group of entries in the cyclic sequence based on the initial location and a predefined group size, to perform a predefined operation on an initial portion of input data and the initial group of entries in the cyclic sequence, and to repeat the predefined operation for each of the remaining portions of input data and a corresponding group of entries in the cyclic sequence.

15. The apparatus of claim 14 wherein the location identifier is to determine the possible output values of the LFSR.

16. The apparatus of claim 14 wherein the possible output values of the LFSR are not dependent on the input data.

17. The apparatus of claim 14 further comprising:
an array of location entries to be searched for the initial location in the cyclic sequence of entries using an initial state of the LFSR, each location entry in the array including a state of the LFSR and an associated location in the cyclic sequence of entries.

18. The apparatus of claim 17 the initial state of the LFSR is received with the input data.

19. The apparatus of claim 17 wherein each state of the LFSR is a decimal value resulting from conversion of a corresponding set of binary values of LFSR storage elements.

20. The apparatus of claim 14 wherein the data manipulator is to execute the predefined operation by storing the initial group of input data in a first register, storing the initial group of input data in a second register, and storing results of the predefined operation in a third register.

21. The apparatus of claim 20 wherein the predefined group size is a size of the first register.

22. The apparatus of claim 14 wherein the predefined operation is an XOR instruction.

23. The apparatus of claim 14 wherein the predefined operation is part of any one of a scrambler algorithm, a whitening algorithm, and a pilot insertion algorithm.

24. The apparatus of claim 14 wherein each of the remaining portions of input data and a corresponding group of entries in the cyclic sequence are of the predefined group size.

25. A computer system comprising:
a memory to store a cyclic sequence of entries representing a set of possible output values of a linear feedback shift register (LFSR); and
a processor, coupled to the memory, to identifying an initial location in the cyclic sequence, to identify an initial group of entries in the cyclic sequence based on the initial location and a predefined group size, to identify an initial portion of input data based on the predefined group size, to perform a predefined operation on the initial portion of input data and the initial group of entries in the cyclic sequence, and to repeat the predefined operation for each of the remaining portions of input data and a corresponding group of entries in the cyclic sequence.

26. The system of claim 25 wherein the possible output values of the LFSR are not dependent on the input data.

27. The system of claim 15 wherein the memory is to store an array of location entries, each location entry in the array including a state of the LFSR and an associated location in the cyclic sequence of entries, the processor is to search the array of location entries for the initial location in the cyclic sequence of entries using an initial state of the LFSR.

28. A computer readable medium that provides instructions, which when executed on a processor, cause said processor to perform operations comprising:
identifying an initial location in a cyclic sequence of entries representing a set of possible output values of a linear feedback shift register (LFSR);
identifying an initial group of entries in the cyclic sequence based on the initial location and a predefined group size;
identifying an initial portion of input data based on the predefined group size;
performing a predefined operation on the initial portion of input data and the initial group of entries in the cyclic sequence; and
repeating the predefined operation for each of the remaining portions of input data and a corresponding group of entries in the cyclic sequence.

29. The computer readable medium of claim 28 wherein the possible output values of the LSFR are not dependent on the input data.

30. The computer readable medium of claim 28 providing further instructions causing the processor to perform operations comprising:
defining an array of location entries, each location entry in the array including a state of the LFSR and an associated location in the cyclic sequence of entries; and
searching the array of location entries for the initial location in the cyclic sequence of entries using an initial state of the LFSR.
